(19) United States
(12) Patent Application Publication
(10) Pub. No.: US 2025/0272581 A1
(43) Pub. Date: Aug. 28, 2025

(54) DYNAMIC AND DOMAIN-SPECIFIC RESPONSE DETERMINATION FOR A VIRTUAL ASSISTANT FOR MULTI-DWELLING UNITS

(71) Applicant: EDST, LLC, Lubbock, TX (US)

(72) Inventors: Shawn Christopher MASSIE, Lubbock, TX (US); Juan Jose Martinez ACOSTA, Lubbock, TX (US)

(21) Appl. No.: 18/590,870

(22) Filed: Feb. 28, 2024

(51) Int. Cl. G06N 5/022

(52) U.S. Cl. CPC G06N 5/022

(57) ABSTRACT

The present disclosure provides systems, methods, and computer-readable storage devices for enabling user management and control of responses of a virtual assistant for use in responding to questions related to multi-dwelling units. To illustrate, an input vector may be determined for received user input containing a question. A relevant document vector and predetermined response may be selected based on the input vector. Similarity scores may be computed between the input vector and each of the document vector and the predetermined response. The document vector or the predetermined response may be selected based on the similarity scores and may be provided, with the input vector, to a model to determine a response that is output as an answer to the question.

### TECHNICAL FIELD

The present application is generally related to the technical field of virtual assistants for responding to questions related to multi-dwelling units, and more particularly, but not by way of limitation, to systems that support user-customizable and domain-specific responses for such virtual assistants.

### BACKGROUND

Artificial intelligence (AI) technology and applications have experienced a remarkable pace of research and growth. For example, the applications of AI have been explored in a variety of contexts, such as data forecasting, automated vehicles, natural language processing, anomaly detection, and many others. One branch of AI applications that have been embraced by tech-savvy companies are AI-based conversational interfaces, which enable an automated interface between a customer and a computer system of a company instead of an interface between the customer and a human employee. Such conversational interfaces may enable the customer to discover information stored at the company system in a more natural, human way than less sophisticated technology, such as using a web browser to display contents of a database and enable access to the materials via mouse or touchscreen movements, queries, and the like. Instead, conversational interfaces may enable a user to learn information by asking questions and providing replies, and the AI-based conversational interfaces may provide responses or ask questions in order to provide the user with relevant information or direct them to additional resources. Depending on the implementation details of the conversational interface, the conversing between the user and the interface may be performed via text, speech and audio, gestures, animated or multimedia displays, or other techniques. As an example, a user of a computer may type questions using a keyboard, and the corresponding responses may be displayed on a monitor. As another example, a user of a mobile phone may speak a question that is captured by a microphone of the mobile phone, and the response may be provided as synthesized speech output by a speaker of the mobile phone, optionally in combination with an avatar or other visual information on a display of the mobile phone.

Two illustrative examples of conversational interfaces are known as “chatbots” and “virtual assistants.” Chatbots may refer to AI-based computer programs that acquire information from a user, such as product information, and provide the information to human technical support technician(s). Chatbots may also refer to AI-based computer programs that provide information to a user, such as an automated call-routing program. For example, a customer of an insurance company may be provided with access to a chatbot that is configured to ask questions about the customer's insurance policy and reason for contacting the insurance company in order to route the customer to the appropriate employee or information source. Virtual assistants typically refer to AI-based computer programs that perform activities to assist in conducting business or managing day-to-day schedules, such as reminding a user of a meeting, managing a to-do list, recording notes, managing smart device settings, and the like. For example, a virtual assistant may be executed by a mobile phone to enable a user to provide voice commands to call a particular phone number, to hear a reading of events scheduled today in a calendar stored at the mobile phone, to adjust a temperature setting of a smart thermostat in their home, and the like. In some literature, virtual assistants are considered as more advanced than chatbots due to the virtual assistants' ability to interact with other applications and perform activities beyond responding to questions or requests for information, and some virtual assistants' emotional and contextual understanding. However, such distinctions are largely cosmetic, as the AI technology underlying both chatbots and virtual assistants is similar, and as technology advances and customer requirements increase in specificity and complexity, chatbots are being designed to provide more options with greater context and emotional sensitivity, further blurring the lines between chatbots and virtual assistants. Accordingly, conversational interfaces are increasingly being referred to interchangeably as chatbots or virtual assistants.

One problem with virtual assistants (e.g., conversational interface, chatbots, etc.), is that designing and configuring virtual assistants can be complicated and time consuming, often requiring significant time by experienced computer programmers or software engineers. As many companies that could benefit from virtual assistants do not have access to these resources, the companies may contract with a developer to provide a virtual assistant tailored to their specific requirements. To design a customer-specific virtual assistant, the developer generates the responses to be provided by the virtual assistant and links them to the questions that prompt the responses, often through specific coding and/or generation of database entries. If the customer's relevant information is not obvious to the developer, the customer must communicate to the developer the information to be covered by the virtual assistant's responses, which can be time-consuming, result in sharing of private or confidential information, and be prone to human error. Additionally, once the virtual assistant is designed and generated, the functionality of the virtual assistant is difficult or impossible to modify without skill in computer programming or database maintenance. If the customer desires to add new questions or responses, or change the linking between questions or responses, such as due to updated information, changes to a customer's business, or the like, the customer must invest in learning the technology or rehire the developer, which can increase cost and reduce utility associated with the virtual assistant.

### BRIEF SUMMARY

Aspects of the present disclosure provide systems, methods, devices, and computer-readable storage media that support user management and customization of responses for virtual assistants (e.g., conversational interfaces, chatbots, etc.) configured to respond to questions related to properties, such as properties that include multi-dwelling units (MDUs) or other types of buildings. The management and customization of response may be facilitated by a user interface (UI), such as a graphical user interface (GUI), that enables a user to select or modify and cause storage of predetermined responses for virtual assistants without requiring computer code of the virtual assistant to be modified, such as by a computer programmer or software engineer. An entity user, such as a manager of one or more MDUs, may access the GUI to select a response (e.g., from stored responses) or enter a new response to a question that may be asked of the virtual assistant, and the system may store and prioritize the user-selected or user-created response accordingly. Thus, the system may perform semi-automated management and customization of virtual assistant responses without requiring rewriting of computer code of the virtual assistant. The system may also leverage artificial intelligence and machine learning to extract responses to domain-specific questions from an input document with little to no user input. In certain implementations, responses may be determined in response to received questions (such as in real time) received from users. For example, the systems discussed herein may be used to select between predetermined responses received from managers and other administrative users and information contained within previously-submitted documents when generating responses.

To illustrate, a server (or other computing device) may enable display of a GUI to an entity user (e.g., a manager of one or more MDUs). The entity user may enter a question to be answered by a virtual assistant (e.g., a text-based virtual assistant, an audio-based virtual assistant, a multimedia-based virtual assistant, or a combination thereof). The server may identify relevant document(s) within a knowledge database that contain information relevant to the question. The server may also retrieve one or more predetermined responses from a response database of virtual assistant responses for display via the GUI. The server may then determine a response to the received question. For example, the server may select between the predetermined response(s) and the relevant document(s). The selected information may be provided to a model, such as a large language model (LLM), along with an indication of the question (such as an input vector determined based on the received question). The model may then determine a response to the question based on the selected information and the indication of the question.

The present disclosure describes systems, methods, apparatus, and computer-readable media that provide benefits compared to conventional virtual assistants. For example, the systems described herein enable dynamic management and customization of responses for use by virtual assistants, particularly virtual assistants used to answer questions related to MDUs or other properties. The systems and methods described herein may enable an entity, such as an owner of an MDU to provide customized virtual assistant support to customers without requiring the costs and computer expertise needed to reprogram a virtual assistant or program and manage a response database. Additionally, the systems and methods described herein provide for approval and use of user-created entries from a particular user by other users. By incorporating user-created responses into a response pool for other users, an entity that offers virtual assistant management and customization to clients may be able to provide more relevant responses without requiring the entity to learn details of the domains of questions and responses used by the clients. Additionally, artificial intelligence and machine learning may be leveraged to enable automated generation of responses from input documents, thereby enabling creation of relevant, specific responses with reduced (or eliminated) user input.

A first aspect provides a method that includes generating an input vector based on a user input that indicates a question regarding a first property characteristic of a plurality of property characteristics associated with a knowledge database; providing the input vector to a first machine learning model to identify a document vector within the knowledge database and associated with the first property characteristic based on the input vector; comparing a first similarity score based on the input vector and the document vector to a second similarity score based on the input vector and a response of a plurality of responses of a response database, the response associated with the first property characteristic; providing, based on the comparison of the first similarity score and the second similarity score, the input vector and at least one of (i) the document vector, (ii) the response, or (iii) a combination thereof to a large language model (LLM) to generate response content; and outputting the response content as an answer to the question.

In a second aspect, in combination with the first aspect, comparing the first similarity score to the second similarity score includes determining that the first similarity score is less than or equal to the second similarity score, and providing, based on the comparison of the first similarity score and the second similarity score, the input vector and one of (i) the document vector, (ii) the response, or (iii) a combination thereof to the LLM comprises providing the input vector and the predetermined response to the LLM to generate the response content.

In a third aspect, in combination with the first aspect, comparing the first similarity score to the second similarity score includes determining that the first similarity score is greater than the second similarity score, and providing, based on the comparison of the first similarity score and the second similarity score, the input vector and one of (i) the document vector, (ii) the response, or (iii) a combination thereof to the LLM comprises providing the input vector and the document vector to the LLM to generate the response content.

In a fourth aspect, in combination with one or more of the first aspect through the third aspect, the response is selected as having the highest similarity measure to the input vector from among a plurality of predetermined responses.

In a fifth aspect, in combination with one or more of the first aspect through the fourth aspect, the first machine learning model is configured to query a document vector database to identify the document vector that is most similar to the input vector.

In a sixth aspect, in combination with the fifth aspect, the knowledge database contains summaries of a plurality of documents associated with the plurality of properties.

In a seventh aspect, in combination with one or more of the first aspect through the sixth aspect, the method further comprises, prior to generating the input vector, receiving the plurality of documents that contain information associated with a plurality of multi-unit properties; and determining, for each respective document of the plurality of documents, a corresponding document vector based on text data within the respective document.

In an eighth aspect, in combination with one or more of the first aspect through the seventh aspect, the method further comprises comparing information associated with the document vector to a plurality of constraints, wherein the constraints are defined based on user input; determining that the information associated with the document vector violates at least one of the plurality of constraints; and selecting a different document vector.

In a ninth aspect, in combination with the eighth aspect, the constraints comprise access level permissions for the knowledge database associated with the user.

In a tenth aspect, in combination with one or more of the first aspect through the ninth aspect, the method further comprises comparing the response from the LLM to a plurality of constraints, wherein the constraints are defined based on user input; determining that the response violates at least one of the plurality of constraints; and providing an indication of the at least one of the plurality of constraints to the LLM to generate updated response content.

In an eleventh aspect, in combination with the tenth aspect, the constraints comprise stylistic requirements for answers presented to users.

In a twelfth aspect, in combination with one or more of the first aspect through the eleventh aspect, the method further comprises converting the user input into text data, wherein the input vector is determined based on the text data.

In a thirteenth aspect, in combination with one or more of the first aspect through the twelfth aspect, generating the input vector comprises extracting contextual details from the user input, wherein the input vector is generated based on the contextual details.

In a fourteenth aspect, in combination with the thirteenth aspect, generating the input vector further includes providing the user input to a second machine learning model, wherein the second machine learning model is trained to extract contextual details from user input and to determine input vectors based on the contextual details.

A fifteenth aspect includes a system that comprises a processor and a memory storing instructions which, when executed by the processor, cause the processor to perform operations. These operations may include generating an input vector based on a user input that indicates a question regarding a first property characteristic of a plurality of property characteristics associated with a knowledge database; providing the input vector to a first machine learning model to identify a document vector within the knowledge database and associated with the first property characteristic based on the input vector; comparing a first similarity score based on the input vector and the document vector to a second similarity score based on the input vector and a response of a plurality of responses of a response database, the response associated with the first property characteristic; providing, based on the comparison of the first similarity score and the second similarity score, the input vector and at least one of (i) the document vector, (ii) the response, or (iii) a combination thereof to a large language model (LLM) to generate response content; and outputting the response content as an answer to the question.

In a sixteenth aspect, in combination with the fifteenth aspect, comparing the first similarity score to the second similarity score includes determining that the first similarity score is less than or equal to the second similarity score, and providing, based on the comparison of the first similarity score and the second similarity score, the input vector and one of (i) the document vector, (ii) the response, or (iii) a combination thereof to the LLM includes providing the input vector and the predetermined response to the LLM to generate the response content.

In a seventeenth aspect, in combination with the fifteenth aspect, comparing the first similarity score to the second similarity score includes determining that the first similarity score is greater than the second similarity score, and providing, based on the comparison of the first similarity score and the second similarity score, the input vector and one of (i) the document vector, (ii) the response, or (iii) a combination thereof to the LLM includes providing the input vector and the document vector to the LLM to generate the response content.

In an eighteenth aspect, in combination with one or more of the fifteenth aspect through the seventeenth aspect, the first machine learning model is configured to query a document vector database to identify the document vector that is most similar to the input vector.

In a nineteenth aspect, in combination with one or more of the fifteenth aspect through the eighteenth aspect, the operations further include comparing information associated with the document vector to a plurality of constraints, wherein the constraints are defined based on user input; determining that the information associated with the document vector violates at least one of the plurality of constraints; and selecting a different document vector.

In a twentieth aspect, in combination with one or more of the fifteenth aspect through the nineteenth aspect, the operations further include comparing the response from the LLM to a plurality of constraints, wherein the constraints are defined based on user input; determining that the response violates at least one of the plurality of constraints; and providing an indication of the at least one of the plurality of constraints to the LLM to generate updated response content.

The foregoing has outlined rather broadly the features and technical advantages of the present disclosure in order that the detailed description that follows may be better understood. Additional features and advantages will be described hereinafter which form the subject of the claims of the present disclosure. It should be appreciated by those skilled in the art that the conception and specific implementations disclosed may be readily utilized as a basis for modifying or designing other structures for carrying out the same purposes of the present disclosure. It should also be realized by those skilled in the art that such equivalent constructions do not depart from the scope of the present disclosure as set forth in the appended claims. The novel features which are believed to be characteristic of the aspects of this disclosure, both as to the organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying figures, in which:

FIG. 1 is a block diagram of an example of a system that supports dynamic management of responses for a virtual assistant associated with management of multi-dwelling units (MDUs) according to one or more aspects;

FIG. 2 is an example of a database of virtual assistant responses according to one or more aspects;

FIG. 3 is an example of a user interface that supports dynamic management of responses for virtual assistants according to one or more aspects;

FIG. 4 is a block diagram of an example of a system that supports providing domain-specific responses to a virtual assistant associated with management of MDUs according to one or more aspects;

FIG. 5 is an example of a user interface for uploading documents to a knowledge database for use in providing domain-specific responses to a virtual assistant associated with management of MDUs according to one or more aspects; and

FIG. 6 is a flow diagram of an example of a method for dynamic management of responses for a virtual assistant associated with management of MDUs according to one or more aspects.

Although the present disclosure and its advantages have been described in detail, it should be understood that various changes, substitutions and alterations can be made herein without departing from the scope of the disclosure as defined by the appended claims. Moreover, the scope of the present application is not intended to be limited to the particular aspects of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or steps.

### DETAILED DESCRIPTION

Inventive concepts of the present disclosure utilize a system to support user management and customization of responses for virtual assistants configured to respond to questions related to multi-dwelling units (MDUs). It may be appreciated that the subject matter described herein generally shifts most of the management of responses for virtual assistants from the developer side (e.g., computer programmers) to the client side (e.g., an entity for which the virtual assistant is developed). For example, client side entities may be able to provide desired responses for the virtual assistant and/or may be able to provide information (e.g., documents) that can be used to answer questions about specific MDUs. As used herein, a virtual assistant may refer to any type of program, application, or the like, that is configured to receive questions or requests from user input and to automatically respond to the questions or requests with one or more predefined responses. The term virtual assistant may be used herein interchangeably to refer to virtual assistants, chatbots, conversational interfaces, or any similar type of artificial intelligence (AI) application. The virtual assistants may be text-based, audio-based, animated, avatars, multimedia-based, or any combination thereof. The management and customization of responses for the virtual assistant may be facilitated by a user interface (UI) configured to enable an entity user to select or modify and cause storage of responses for virtual assistants. These responses may be stored in one or more response databases that are designated for use by virtual assistant(s) to retrieve responses. Thus, the systems and methods of the present disclosure support significant dynamic management and customization of virtual assistant responses without requiring computer code of the virtual assistant to be modified, such as by a computer programmer or software engineer. The present disclosure also utilizes a system to support automated or semi-automated generation of responses for virtual assistants configured to respond to questions related to MDUs. To illustrate, the system may leverage artificial intelligence and machine learning to extract responses to domain-specific question(s) from input document(s) with little to no user input. Thus, an entity user of the system may provide highly relevant, specific information to customers via virtual assistants based on paper or electronic documents without requiring the user to read the documents, derive responses from the documents, and manually enter the derived responses. Although described herein in the context of responses for virtual assistants configured for use by managers of MDUs, the disclosure is not so limited, and implementations described herein may be used to improve management, customization, and generation of responses for virtual assistants configured to operate in other contexts, such as government, health, corporate, sales, non-profits, houses of worship, media streaming, entertainment and gaming, or other contexts, as non-limiting examples.

Certain units described in this specification have been labeled as modules in order to more particularly emphasize their implementation independence. A module is “[a] self-contained hardware or software component that interacts with a larger system.” Alan Freedman, “The Computer Glossary” 268 (8th ed. 1998). A module may comprise a machine- or machines-executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions that may be organized as an object, procedure, or function. Nevertheless, the executables of an identified module need not be physically located together, but may comprise disparate instructions stored in different locations that, when joined logically together, comprise the module, and when executed by the processor, achieve the stated data transformation. A module of executable code may be a single instruction, or many instructions, and may even be distributed over several different code segments, among different programs, and/or across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present aspects. One skilled in the relevant art will recognize, however, that aspects of the disclosure may be practiced without one or more of the specific details, or with other methods, components, materials, and so forth. In other instances, well-known structures, materials, or operations are not shown or described in detail to avoid obscuring aspects of the disclosure.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed aspect, the term “substantially” may be substituted with “within [a percentage] of” what is specified, where the percentage includes 0.1, 1, or 5 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Similarly, the phrase “A, B, C, or a combination thereof” or “A, B, C, or any combination thereof” includes A alone, B alone, C alone, a combination of A and B, a combination of A and C, a combination of B and C, or a combination of A, B, and C.

The terms “comprise” (and any form of comprise, such as “comprises” and “comprising”), “have” (and any form of have, such as “has” and “having”), and “include” (and any form of include, such as “includes” and “including”). As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any implementations of any of the systems, methods, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where.”

Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

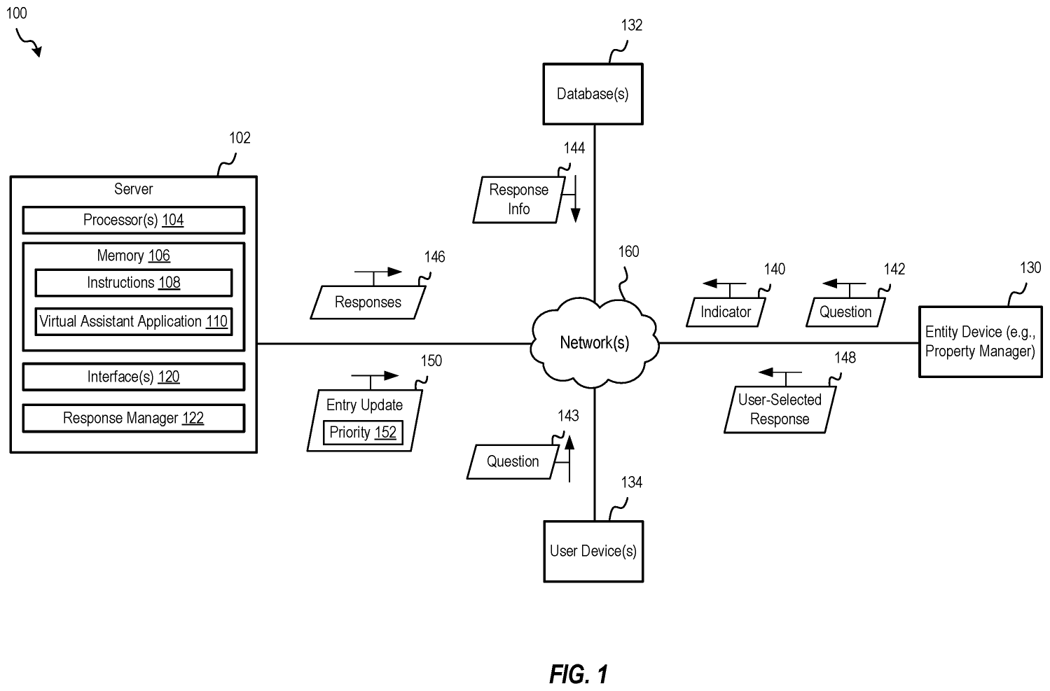

Referring to FIG. 1, a block diagram of an example of a system that supports dynamic management of responses for a virtual assistant associated with management of MDUs according to one or more aspects is shown and designated 100. As shown in FIG. 1, the system 100 includes a server 102, an entity device 130, one or more databases 132 (referred to herein as “the databases 132”), one or more user devices 134 (referred to herein as “the user devices 134”), and one or more networks 160. In some implementations, one or more components of the system 100 may be optional, or the system 100 may include additional components, such as additional entity devices, training devices, cloud processing or storage devices, or the like, as non-limiting examples.

The server 102 may be configured to execute, support, and maintain one or more virtual assistants for use by one or multiple entities, including an entity associated with the entity device 130. Although described as a server 102, in some other implementations, functionality described herein with reference to the server 102 may be performed by a different type of electronic device, such as a desktop computing device, a laptop computing device, a personal computing device, a tablet computing device, a mobile device (e.g., a smart phone, a tablet, a personal digital assistant (PDA), a wearable device, and the like), a virtual reality (VR) device, an augmented reality (AR) device, an extended reality (XR) device, a vehicle (or a component thereof), an entertainment system, other computing devices, or a combination thereof, as non-limiting examples. The server 102 includes one or more processors 104, a memory 106, one or more communication interfaces 120, and a response manager 122. In some other implementations, one or more of the components may be optional, one or more additional components may be included in the server 102, or both. It is noted that functionalities described with reference to the server 102 are provided for purposes of illustration, rather than by way of limitation and that the exemplary functionalities described herein may be provided via other types of computing resource deployments. For example, in some implementations, computing resources and functionality described in connection with the server 102 may be provided in a distributed system using multiple servers or other computing devices, or in a cloud-based system using computing resources and functionality provided by a cloud-based environment that is accessible over a network, such as one of the one or more networks 160. To illustrate, one or more operations described herein with reference to the server 102 may be performed by multiple servers or a cloud-based system that communicates with one or more client or user devices, one or more entity devices, or the like.

The one or more processors 104 may include one or more microcontrollers, application specific integrated circuits (ASICs), field programmable gate arrays (FPGAs), central processing units (CPUs) having one or more processing cores, or other circuitry and logic configured to facilitate the operations of the server 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the server 102 may be stored in the memory 106 as instructions 108 that, when executed by the one or more processors 104, cause the one or more processors 104 to perform the operations described herein with respect to the server 102, as described in more detail below. Additionally, the memory 106 may be configured to store data and information, such as a virtual assistant application 110, one or more response rules 112, and an approval rating 114. Illustrative aspects of the virtual assistant application 110, the response rules 112, and the approval rating 114 are described in more detail below.

The one or more communication interfaces 120 may be configured to communicatively couple the server 102 to the one or more networks 160 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the server 102 includes one or more input/output (I/O) devices that include one or more display devices, a keyboard, a stylus, one or more touchscreens, a mouse, a trackpad, a microphone, a camera, one or more speakers, haptic feedback devices, or other types of devices that enable a user to receive information from or provide information to the server 102. In some implementations, the server 102 is coupled to a display device, such as a monitor, a display (e.g., a liquid crystal display (LCD) or the like), a touch screen, a projector, a VR display, an AR display, an XR display, or the like. In some other implementations, the display device is included in or integrated in the server 102.

The response manager 122 is configured to support management of responses provided by the virtual assistant application 110. In some implementations, the response manager 122 includes or corresponds to a response management module configured to manage responses provided by the virtual assistant application 110. To illustrate, the server 102 may execute the virtual assistant application 110 (e.g., one or more instructions configured to support a virtual assistant) to enable operation of a virtual assistant at one or more other devices, such as the user device 134, the entity device 130, or combinations thereof. The virtual assistant may interact with a user to retrieve information from the user or enable the user to discover information through questioning of the virtual assistant, and communications between the server 102, the databases 132, and the other devices may support the functionality of the virtual assistant. For example, a user of the user device 134 may enter a question via the user device 134, the user device 134 may send the question to the server 102, the server 102 may retrieve a corresponding response from the databases 132, and the server 102 may provide the response to the user device 134 for output to the user. In order to support dynamic management and control of the responses, the response manager 122 may be configured to communicate with the entity device 130 to send and receive data for use in adding, modifying, or removing responses stored at the databases 132 for use by the virtual assistant application 110.

To illustrate management of the responses, the response manager 122 may be configured to receive input from the entity device 130 or the user device 134 that indicates a question 142, 143 to be answered by the virtual assistant application 110. The question 142, 143 may concern a property, such as an MDU. For example, a question 143 may be received from a user device 134 concerning a property in which an associated user is a resident. As another example, a question 142 may be received from an entity device 130 concerning a property in which an associated entity user is a manager. In response to receiving the question 142, 143, the response manager 122 may be configured to retrieve response information 144 from one or more databases 132. The response information 144 may include predetermined responses (e.g., predetermined responses determined by and received from an entity user associated with the property), documents relevant to the received question 142, 143 (e.g., relevant documents concerning the property for which a question is being asked), or a combination thereof. The response manager 122 may then select between the predetermined responses and the relevant documents for further use in determining a response to the received question 142, 143. For example, the response manager 122 may utilize (e.g., directly or indirectly) an LLM to generate responses 146 to received questions 142, 143 based on corresponding selected inputs, as discussed further herein. In certain implementations, the response manager 122 may enforce access level restrictions, predefined constraints, or combinations thereof for determined responses 146. For example, responses that violate the restrictions or constraints may be regenerated in order to comply. Responses 146 may then be output by the server 102 for display or presentation at the device (e.g., entity device 130, user device 134) from which the question 142, 143 is received.

In some implementations, the response manager 122 may include or access (e.g., at the memory 106, a storage device of the server 102, or a device that is coupled to or accessible to the server 102 via the one or more networks 160) a first set of one or more machine learning (ML) models that are configured to perform various tasks when determining responses to user questions. In some implementations, the ML models discussed herein may be implemented as one or more neural networks (NNs). In some other implementations, the ML models discussed herein may be implemented as other types of ML models or constructs, such as support vector machines (SVMs), decision trees, random forests, regression models, Bayesian networks (BNs), dynamic Bayesian networks (DBNs), naive Bayes (NB) models, Gaussian processes, hidden Markov models (HMMs), regression models, and the like.

In some implementations, the response manager 122 may include or access one or more language models, such as one or more large language models (LLMs). Language models may be configured to determine text output based on one or more inputs (such as text inputs). In particular, LLMs are advanced machine learning models that are trained on a vast amount of text data. They operate by analyzing the input text and predicting the next word or phrase based on the context provided by the preceding words. In particular, LLMs may receive a tokenized text input and may predict the output based on the tokenized input. Such models are able to generate human-like text, answer questions, translate languages, and perform a variety of other language-related tasks. Certain implementations may utilize one or more transformer models, such as generative pre-trained transformer models. For instance, LLMs as used herein may include GPT models from OpenAI (R), BERT models from Google (R), or similar models from other providers. These models can be run locally on a computing device (such as a server device). Alternatively, they can also be accessed via API calls to a server (such as a cloud computing provider) where the model is hosted.

One or more of the models discussed herein may be trained by the server or another computing device. For example, one or more training datasets may be used that contain training data for corresponding model(s). The training data may specify one or more expected outputs. Parameters of the model(s) may be updated based on whether the model(s) generate correct outputs when compared to the expected outputs. In particular, the model(s) may receive one or more pieces of input data from the training data sets that are associated with a plurality of expected outputs. The model(s) may generate predicted outputs based on a current configuration of the model(s). The predicted outputs may be compared to the expected outputs and one or more parameter updates may be computed based on differences between the predicted outputs and the expected outputs. In particular, the parameters may include weights (e.g., priorities) for different features and combinations of features. The parameter updates to the model(s) may include updating one or more of the features analyzed and/or the weights assigned to different features or combinations of features (e.g., relative to the current configuration of the models).

The entity device 130 may be configured to communicate with the virtual assistant application 110. For example, the entity device 130 may transmit questions 142 to the virtual assistant application 110 and may receive responses 146, which may be determined by the response manager 122 according to the techniques discussed herein. The entity device 130 may also be configured to communicate with the server 102 to enable management and customization functions associated with the virtual assistant application 110. For example, the entity device 130 may be configured to output a UI that enables an entity user of the entity device 130 to input a question to be answered by the virtual assistant application 110 and to manage predetermined responses corresponding to the question, such as by ordering or prioritizing the responses, adding one or more additional responses, modifying one or more existing responses, deleting one or more responses, setting or adjusting parameters or configurations associated with the virtual assistant application 110, or a combination thereof. The entity device 130 may include or correspond to a mobile device (e.g., a smart phone, a tablet, a PDA, a wearable device, and the like), a desktop computing device, a laptop computing device, a personal computing device, a tablet computing device, a server, a VR device, an AR device, an XR device, a vehicle (or a component thereof), an entertainment system, other computing or electronic devices, or a combination thereof, as non-limiting examples. The entity device 130 may be associated with an entity for one or more properties. In particular, the entity device 130 may be associated with an entity user associated with one or more entity users associated with one or more properties (such as managers, owners, or other users associated with the one or more properties). For example, the entity device 130 may be associated with (e.g., owned, maintained, or used by) a manager of one or more MDUs. To further illustrate, the entity device 130 may be a computer used by a company that leases multiple apartment complexes in one or more geographic regions, as a non-limiting example. Although one entity device 130 is shown in FIG. 1, in some other implementations, additional entity devices associated with other entities, the same entity that is associated with the entity device 130, or both, may be included in the system 100.

The databases 132 (e.g., one or more response databases) are configured to store responses for use by the virtual assistant application 110 and/or other virtual assistant applications provided to the entity associated with the entity device 130 or other entities. The responses may include text data, image data, combinations of text and image data (e.g., electronic document data), audio data, multimedia data, or any other type of data that may be provided by virtual assistant applications. The databases 132 may be configured to store entries that include responses for use by the virtual assistant applications and information associated with the responses, such as priority indicators, training phrase(s), summaries, links to related users, MDUs, or domains, approval flags, and the like. Some entries may be stored in the databases 132 during design and generation of the virtual assistant applications, and some entries may be stored in the databases 132 by the server 102 or entity devices (e.g., the entity device 130) during the operational lifetime of the virtual assistant applications. Although illustrated in FIG. 1 as a single database, in some other implementations, the databases 132 include multiple communicatively coupled databases. In some implementations, each of the databases 132 may be configured to store a particular type of responses. For example, each of the databases 132 may be configured to store responses that correspond to different entities, responses the correspond to different MDUs, responses that correspond to different types of MDUs, responses that correspond to different virtual assistant applications, responses that correspond to different questions or types of questions, or the like.

The databases 132 (e.g., one or more knowledge databases) may be configured to store data regarding one or more properties. As discussed further below, this data may be used as response information 144 when generating responses 146 to received questions 142, 143. In particular implementations, the knowledge databases may be configured to store copies of documents received from entity users (such as documents concerning one or more properties that are received from entity devices associated with users acting on behalf of entities, such as property managers for those properties). Knowledge databases may additionally or alternatively be configured to store data derived from such received documents. For example, the knowledge databases may be configured to store text data extracted from the received documents. As another example, the knowledge databases may be configured to store vector representations of the received documents and/or vector representations of generated summaries for the received documents. Although illustrated as a single database, in some other implementations, the databases 132 may include multiple communicatively coupled databases. In some implementations, each of the databases 132 may be configured to store a particular type of data (such as separate databases for documents and document vectors). In additional or alternative implementations, separate databases may be maintained for separate properties or separate collections of properties.

The user device 134 is configured to communicate with the server 102 to execute the virtual assistant application 110. For example, the user device 134 may be configured to provide a virtual assistant to a user by sending and receiving data to and from the server 102, such as sending questions or requests to be answered by the virtual assistant and receiving responses to be output at the user device 134. To further illustrate, the user device 134 may execute an instance of the virtual assistant application 110 to display a graphical user interface (GUI) that displays text corresponding to the questions, the responses, or both, images corresponding to the questions, the responses, or both, animation or video that corresponds to the questions, the responses, or both, other information, or a combination thereof. Additionally or alternatively, the user device 134 may render audio output, such as synthesized speech, that corresponds to the questions, the responses, or both, other information, or a combination thereof. As an illustrative example, the virtual assistant application 110 may be a virtual assistant for residents of the one or more MDUs managed by the entity associated with the entity device 130, and the user device 134 may enable a user to ask questions to obtain information related to the one or more MDUs or to initiate performance of one or more actions with respect to the one or more MDUs. As noted above, the entity device 130 may also be configured to communicate with the virtual assistant application 110. The user device 134 may include or correspond to a mobile device (e.g., a smart phone, a tablet, a PDA, a wearable device, and the like), a desktop computing device, a laptop computing device, a personal computing device, a tablet computing device, a server, a VR device, an AR device, an XR device, a vehicle (or a component thereof), an entertainment system, other computing or electronic devices, or a combination thereof, as non-limiting examples. The user device 134 may be operated by a customer/client or potential customer/client of an entity. For example, the user device 134 may be associated with a resident of the one or more MDUs managed by the entity associated with the entity device 130, or with a prospective resident that is interested in obtaining information about the one or more MDUs. Although one user device 134 is shown in FIG. 1, in some other implementations, additional user devices associated with other current (or prospective) residents, lessees, tenants, renters, occupants, etc., of MDUs managed by the same entity that is associated with the entity device 130, other entities, or both, may be included in the system 100.

During operation of the system 100, the server 102 may execute the virtual assistant application 110 to provide virtual assistant services to one or more other devices, such as the user device 134. The virtual assistant application 110 may correspond to the entity associated with the entity device 130 and may be provided to current and prospective customers of the entity. As a non-limiting example, the entity may manage one or more properties, and the virtual assistant application 110 may be configured to provide a virtual assistant for current or prospective occupants (e.g., renters, lessees, tenants, etc.) of the one or more properties to provide information related to the one or more properties, to enable performance of one or more operations associated with the one or more properties, or a combination thereof. In this example, the entity may be a property manager of multiple apartment complexes, and the virtual assistant application 110 may be configured to provide text-based, audio-based, image or video-based, multimedia-based, or a combination thereof, virtual assistant functionality to enable access to information about the apartment complexes, such as floorplans of various units, monthly rents for various units, rules regarding use of common areas, details of leases, and the like, and/or to enable performance of one or more activities, such as contacting the property manager, initiating electronic rent payment, scheduling a virtual tour of the apartment complexes, and the like. MDUs are properties that typically include multiple separate units within the same building or complex. Some MDUs (also referred to as multi-family residential units (MFRUs)) include multiple different housing or residential units in one or more buildings. Illustrative examples of such MDUs include apartment buildings, mixed use buildings, condominiums, flats, lofts, housing cooperatives (co-ops), penthouses, townhouses, single room occupancies (SROs), studio apartments, tenements, or the like. Other types of MDUs include student housing (e.g., dorms, co-ops, student apartments, etc.), planned communities including combined commercial and residential structures (e.g., mixed use buildings that include store(s), restaurants, and the like in one or more floors or units and apartments, condos, and the like in one or more other floors or units), hotels, boarding houses, military properties (e.g., barracks, etc.), assisted living buildings or communities, hospice or medical treatment buildings or communities, and the like. In still further implementations, the techniques discussed herein may be used with properties that are not MDUs, such as single family homes, commercial properties (e.g., office spaces, warehouses, storage units, malls, and the like), non-commercial properties (such as houses of worship, non-profit facilities, and the like), or combinations thereof. Accordingly, it is to be understood that aspects of the present disclosure are not limited to use with multi-family residential properties.

To further illustrate the functionality of the virtual assistant application 110, a user of the user device 134 may access the virtual assistant, such as by causing a browser executed at the user device 134 to access a website of the entity (or a particular MDU managed by the entity) or by executing an application provided by the entity, which may cause the user device 134 to display a GUI that includes an option for inputting a question (e.g., via text, via speech, etc.) to be answered by the virtual assistant and other information associated with one or more MDUs managed by the entity. The server 102 may receive the question from the user device 134, and an indication of the entity or the MDU, and the server 102 may retrieve one or more responses from the databases 132 that correspond to the question and the indication. For example, the virtual assistant may request the user to enter the name of the entity or the MDU, the user device 134 may provide the internet address accessed by the browser, the user device 134 may provide an identifier associated with the application, the server 102 may access a user profile of the user to determine the indication, or the indication may be obtained by the server 102 in some other manner. As an illustrative example of implementation of the virtual assistant application 110, the user of the user device 134 may be a resident of an apartment at a particular MDU (e.g., “Sunnyside Apartments”) managed by the entity, and the user may enter the question “Are pets allowed at Sunnyside Apartments?” In this example, the server 102 may access the databases 132 based on the question and the indication of Sunnyside Apartments to retrieve two responses linked with the question, which are provided by the server 102 to the user device 134 for outputting to the user. To further illustrate, the GUI at the user device 134 may display the following text: “The pet policy for Sunnyside Apartments may be found here: <link>”, where “<link>” is a link (e.g., a uniform resource locator (URL)) to a copy of an electronic document for the pet policy.

Although the responses stored in the databases 132 at the time the virtual assistant application 110 is designed may provide useful and relevant information to users, such responses may become less informative or outdated after a particular period of time. Additionally or alternatively, new policies, changes to the MDUs, new leases, frequently asked questions, and the like, may render some responses obsolete or incorrect, as well as benefiting from new information being provided by the virtual assistant application 110. Thus, dynamic management of the responses stored in the databases 132 may provide significant benefits to the entity for which the virtual assistant application 110 is designed.

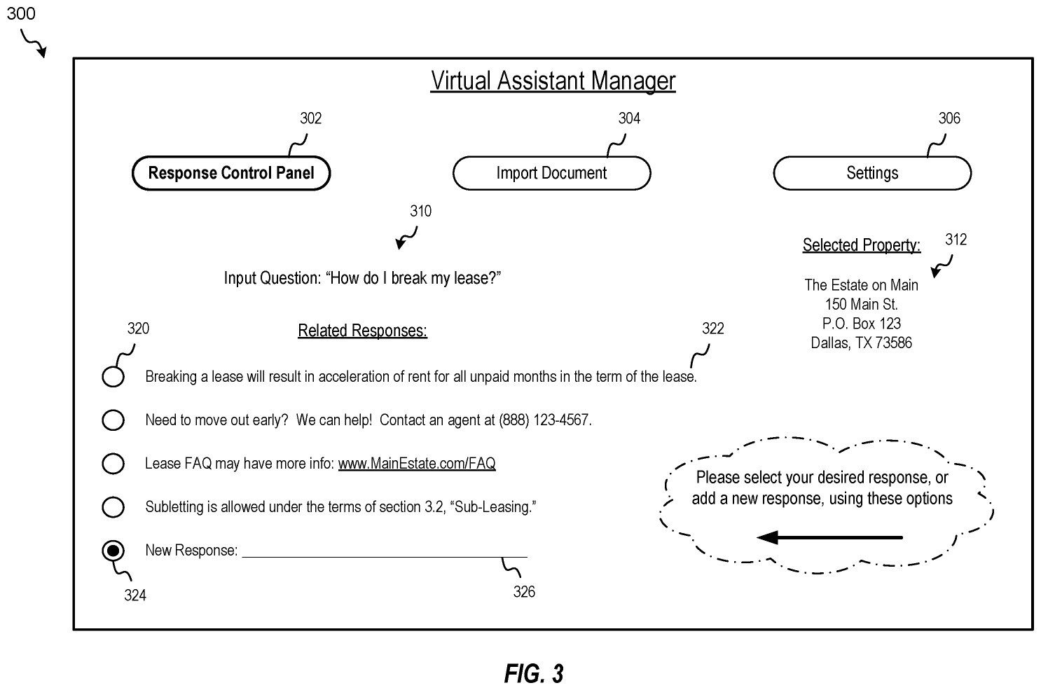

To support dynamic management of responses for use by the virtual assistant application 110, the server 102 may communicate with the entity device 130 to cause output of a UI, such as a GUI, an audio-based UI, or the like, that enables the entity to dynamically modify and prioritize predetermined responses used by the virtual assistant application 110, as well as adding new responses to be used by the virtual assistant application 110. An illustrative example of such a GUI is further described below with reference to FIG. 3. The UI may prompt the entity to enter a question that the virtual assistant application 110 is configured to answer, and responsive to user input, the entity device 130 may provide (e.g., send or transmit, such as via the one or more networks 160) an indicator 140 and a question 142. The indicator 140 may identify or indicate the entity or one or more MDUs for which a response to the question 142 is to be provided. For example, the indicator 140 may include a name or other identifier of a particular MDU (e.g., based on user input) or an entity identifier or entity profile associated with the entity, a device identifier associated with the entity device 130, other information, or a combination thereof, any of which may be mapped to one or more MDUs by information stored at or accessible to the server 102. As an illustrative example, the indicator 140 may include a link (or information representative of the link) accessed by a browser of the entity device 130 to enable management of responses for one or more particular MDUs. As another illustrative example, the indicator 140 may be an entity identifier stored in a profile associated with the entity of the entity device 130. Although illustrated as separate information in FIG. 1, the indicator 140 and the question 142 may be included in the same or different messages from the entity device 130.

For example, the response manager 122 may be configured to maintain a knowledge database of documents related to one or more properties. In particular, the response manager 122 may receive document(s) from the entity device 130 and may determine a document vector for the received document(s). Example documents may include lease or rental agreements, property policies and guidelines, maintenance requests, tenant communications, FAQ documents, rental application forms, incident reports, and the like. In the context of the present disclosure, the term “document vector” may refer to a numerical representation that effectively encapsulates the substantive information of a document (e.g., a text document) within a multi-dimensional vector space. The document vector is structured to allow for rapid and reliable similarity assessments when compared to other vectors within a database. This process of vectorization abstracts the textual content into a form that a computing system can recognize and process, focusing on the semantic meaning and contextual relevance of the document from which it is derived. To generate document vectors, several types of techniques can be employed. For example, the Term Frequency-Inverse Document Frequency (TF-IDF) model creates vectors that reflect the term frequencies within a document while incorporating a weighting factor that diminishes the impact of terms common across multiple documents, thereby accentuating the significance of rarer terms. Latent Semantic Analysis (LSA) leverages singular value decomposition on term-document matrices to not only reduce the number of dimensions in the vector space but also to capture latent relationships and meanings within the corpus of documents. Word2Vec is a neural network-based approach for learning word associations from a substantial collection of text, with the resulting document vectors capturing nuanced meanings and contextual relationships of words. Doc2Vec extends the Word2Vec techniques to encompass whole documents into its vectorization process, ensuring that comprehensive contextual and semantic information is maintained within the generated vectors. BERT (Bidirectional Encoder Representations from Transformers) utilizes state-of-the-art deep learning techniques to generate document vectors that embody the bidirectional context of words, allowing for a deep understanding of the meaning within text documents. One or more of these techniques may be used to determine document vectors for received documents. After determining the document vector, the response manager 122 may store the document, the document vector, a summary of the document, or a combination thereof in one or more databases 132. For example the databases 132 may maintain a knowledge database for one or more associated properties in which a copy of the document vector is stored.

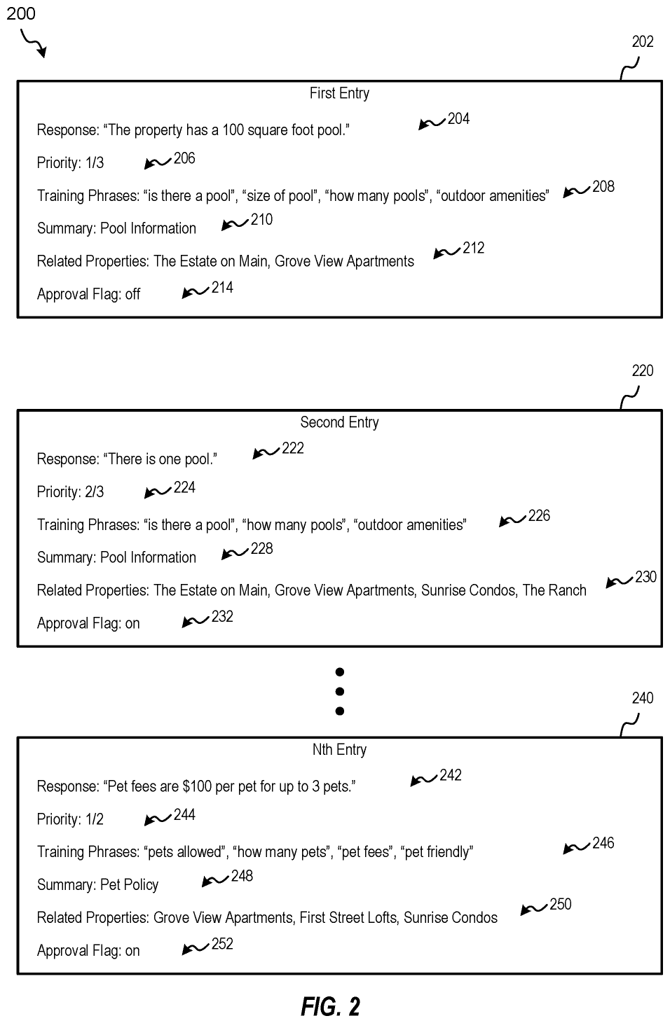

After receiving a predetermined response 148, the response manager 122 may update an entry in the databases 132 based on the response 148. Similarly, after receiving a document, the response manager 122 may update an entry in the databases 132 based on the document. To illustrate, the response manager 122 may generate and provide an entry update 150 to the databases 132. Generating the entry update 150 may include setting a priority 152 associated with the entry. In some implementations, the entry update 150 may include or indicate a response/document (e.g., the user-selected response 148) and optionally, information associated with the response/document, such as the priority 152, corresponding entity or MDUs, one or more corresponding training phrases, other information, or a combination thereof, as further described below (e.g., with reference to FIG. 2). In certain implementations, the entry update may include a vector or other representation of the response/document and related information (such as training phrases).

The databases 132 may receive the entry update 150 and update (e.g., modify or create) an entry in the databases 132 that corresponds to the response indicated by the entry update 150. For example, if the entry update 150 indicates a previously-stored response, an existing entry in the databases 132 may be updated to include the response text, to set a priority value based on the priority 152, or to perform other modifications or updates on fields or portions of the existing entry. As another example, if the entry update 150 indicates a new document, a new entry may be created in (e.g., added to) the databases 132. This new entry may include a representation of the new document (e.g., a summary of the document, a token for the document), a corresponding property/entity, additional information, or a combination thereof. The entries may be associated with the entity or the MDUs managed by the entity (e.g., based on an identifier of the entity or the MDUs received from the entity device 130 or determined by the server 102). Although described as being associated with the entity (or the MDUs), in other implementations, the entries may be associated with other information. For example, the entries may be associated with different types of leases or rental agreements available to current or potential customers, different geographic locations (e.g., due to different state regulations or local laws), different customer types (e.g., residential (short-term, long-term, or periodic), commercial, or the like), other categories, or the like.

As described with reference to FIG. 1, the system 100 enables dynamic management and customization of responses for use by the virtual assistant application 110 by the entity device 130. The system 100 may enable the entity, such as an owner or manager of one or more MDUs, to provide customized virtual assistant support to customers without requiring the costs and computer expertise needed to reprogram the virtual assistant application 110 or to program and manage the databases 132. In particular, the system 100 may enable the entity to establish predetermined responses that are used when they are relevant to received user questions, enabling greater control over virtual assistant behavior without needing to reprogram the virtual assistant application. However, the techniques also enable documents to be stored and used to answer questions in situations where predetermined responses may be less relevant. In particular, relevant documents from a knowledge database can be identified and used to determine responses when they are more relevant to the questions indicated in received user input. This enables questions to be answered based only on relevant information (to reduce hallucinations) while also avoiding the need for entities to manually provide predetermined responses for many different types of questions. Furthermore, the system 100 may allow for entities to define constraints that are applied to generated responses, further ensuring that generated responses comply with desired stylistic and other preferences. These constraints may also be used to enforce access level restrictions for different types of users, allowing the system to be used by many different types of users for different types of questions without having to configure separate virtual assistant applications for the different types of users.

Referring to FIG. 2, an example of a database of virtual assistant responses (e.g., predetermined responses) according to one or more aspects is shown as a database 200. Although referred to as one database, the database 200 may include a single database or multiple databases that store the information described herein. In some implementations, the database 200 may include or correspond to the databases 132 of FIG. 1.

The database 200 is configured to store entries corresponding to responses to be provided by a virtual assistant (e.g., the virtual assistant application 110 of FIG. 1), such as a virtual assistant configured to respond to questions associated with one or more MDUs. As shown in FIG. 2, the database 200 may store a first entry 202, a second entry 220, and an nth entry 240. Although three entries are illustrated in FIG. 2, in other implementations, the database 200 may store fewer than three or more than three entries. Entries in the database 200 may be added, modified, or deleted by a response manager, such as the response manager 122 of FIG. 1. In some implementations, the database 200 may be stored at a memory or storage device of a server (or other electronic device) that executes a response manager, such as the server 102 of FIG. 1. In some other implementations, the database 200 may be external to the server and accessible to the server, such as via a network. As a non-limiting example, the database 200 may be stored at a cloud-based storage platform.

The entries in the database 200 include or indicate the responses and various information associated with responses for use by the virtual assistant, such as priority values, training phrases, summaries, related properties (e.g., MDUs), and approval flags. To illustrate, the first entry 202 may include a first response 204, a first priority 206, first training phrases 208, a first summary 210, first related properties 212, and a first approval flag 214, the second entry 220 may include a second response 222, a second priority 224, second training phrases 226, a second summary 228, second related properties 230, and a second approval flag 232, and the nth entry 240 may include an nth response 242, an nth priority 244, nth training phrases 246, an nth summary 248, nth related properties 250, and an nth approval flag 252. The responses 204, 222, and 242 are responses to questions that the virtual assistant is configured to respond to. For example, the first response 204 and the second response 222 may be responses to the question “Is there a pool?”, and the nth response 242 may be a response to the question “Are pets allowed in the apartment?”

The additional information in each entry is associated with the respective response. The priorities may indicate a priority of a particular response with reference to other responses associated with the same question. In the example of FIG. 2, the first priority 206 is ⅓, which indicates that there are three responses associated with the question and that the first response 204 is the highest priority. The training phrases include words or phrases that may be used to determine questions that correspond to the respective responses, such as based on NLP analysis, training ML models, or the like. For instance, the training phrases may include associated user queries or input vectors that may indicate a question relevant to the provided response. In the example of FIG. 2, the first training phrases include “is there a pool”, “size of pool,” “how many pools,” and “outdoor amenities.” These phrases may be used to identify questions that are to be answered with the first response 204. For example, in addition or alternatively of being linked to the question “Is there a pool?”, the first response 204 may be linked to questions such as “What size pools are there?”, “How many pools does this complex have?”, and “What outdoor amenities do you offer?”, as non-limiting examples. The summaries include a summary of what information is included in the respective response, a summary of questions that correspond to the response, or a combination thereof. In the example of FIG. 2, the first summary 210 includes “pool information,” which summarizes the first response 204. In some other implementations, the summaries may also include question-specific summaries, particular questions linked to the response, or a combination thereof, or the summaries may be omitted. The related properties may indicate one or more properties, such as one or more MDUs, that are associated with the respective response. In the example of FIG. 2, the first response 204 may be associated with two MDUs: The Estate on Main and Grove View Apartments, as indicated by the first related properties 212. Thus, if a user asks the corresponding question and is associated with one of those two MDUs, the virtual assistant should return the first response 204. The approval flags may indicate whether a particular response is approved for use with other entities, MDUs, or both. The approval flags may be set based on the results of an approval process associated with the response. In the example of FIG. 2, the first approval flag 214 is set to an off value to indicate that the first response 204 is not to be used by other entities or MDUs. This setting may be due to the specificity of the first response 204 (e.g., that other entities or MDUs do not have 100 square foot pools), or other factors, such as the first response 204 including restricted language or an entity that created the first response 204 not granting permission to use the first response 204 with other entities or MDUs.

As seen in FIG. 2, different entries may correspond to the same or similar questions, or to different questions. To illustrate, the second response 222 may correspond to the same question as the first response 204, as shown by the similarities between the first training phrases 208 and the second training phrases 226 or the first summary 210 and the second summary 228. Additionally or alternatively, some entries may correspond to different questions. To illustrate, the nth response 242 may correspond to a different question than the first response 204, as shown by the differences between the first training phrases 208 and the nth training phrases 246 or the first summary 210 and the nth summary 248. Some entries may correspond to at least one of the same MDU. For example, the second related properties 230 include the first related properties 212 and two additional MDUs: Sunrise Condos and The Ranch. Accordingly, the first response 204 may be used as a response to the question by a user associated with The Estate on Main or Grove View Apartments, and the second response 222 may be used as a response to the question by a user associated with The Estate on Main, Grove View Apartments, Sunrise Condos, or the Ranch. However, the first response 204 has a higher priority than the second response 222 for The Estate on Main and Grove View Apartments, as indicated by the first priority 206 and the second priority 224. Additionally, the second response 222 may be used for other entities based on the second approval flag 232 having an on value (e.g., the second response 222 may have successfully completed an approval process).

The entries 202, 220, and 240 may be stored or updated based on instructions from a server, such as the server 102, that is configured to enable dynamic management of virtual assistant responses. For example, if the entry update 150 includes or indicates the first response 204, the first entry 202 may be updated with updated values for the first response 204, the first priority 206, the first training phrases 208, the first summary 210, the first related properties 212, the first approval flag 214, other information, or a combination thereof, based on information included in the entry update 150. To further illustrate, the first priority 206 may be modified based on the priority 152. In this manner, the entries 202, 220, and 240 may be stored and maintained to enable dynamic management of virtual assistant responses without requiring rewriting computer code or manually editing entries in a database.

Referring to FIG. 3, an example of a user interface (UI) that supports dynamic management of responses for virtual assistants according to one or more aspects is shown as a UI 300. The UI 300 (e.g., a GUI) may be displayed via a server (e.g., a display device coupled to the server, or another electronic device) that executes a response manager, an administrator device (e.g., associated with an entity such as a property manager of one or more MDUs), a user device (e.g., associated with a current or potential customer or client of the entity), or a combination thereof. In some implementations, the UI 300 may be displayed by the entity device 130 of FIG. 1. As shown in FIG. 3, the UI 300 includes a response control button 302, an import document button 304, a settings button 306, an input question 310, selected property information 312, and one or more related responses. In other implementations, one or more of the illustrated features of the UI 300 may be optional, the UI 300 may include additional features, or both.

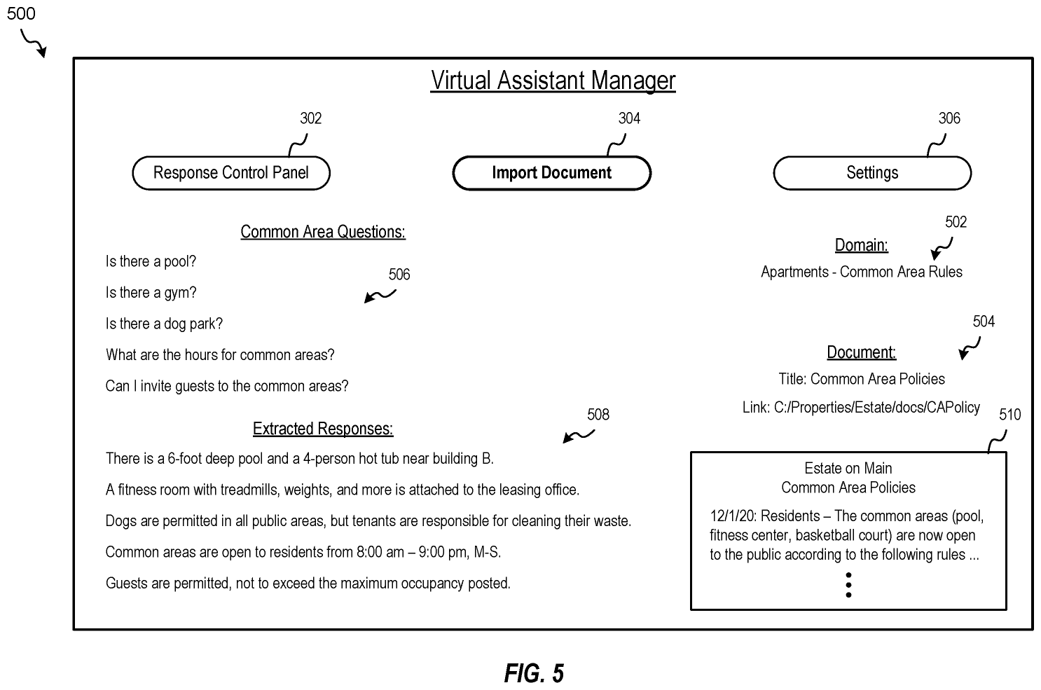

The response control button 302 may be selectable to cause the UI to display the content shown in FIG. 3 to enable a user (e.g., such as a manager of one or more MDUs) to dynamically manage responses for a virtual assistant. The import document button 304 may be selectable to cause the UI to display information and options for generating responses based on a document, as further illustrated with reference to FIG. 5. The settings button 306 may be selectable to display information and options for controlling one or more settings of response management or document analysis, or other settings.

The input question 310 includes a question that is to be answered by the virtual assistant. For example, the virtual assistant may be configured to answer the input question 310 by retrieving one or more corresponding responses from a database and output at least one of the one or more responses. The UI 300 may include a user-configurable option that enables the user to enter the input question 310, such as via a keyboard, touchscreen, or other input device, or by speaking the question for capture by an audio capture device. In the example shown in FIG. 3, the input question 310 is “How do I break my lease?” The selected property information 312 is displayed to indicated to a user which property (e.g., MDU) is currently selected. The selected property is used in retrieving responses to the input question 310 (e.g., the retrieved responses correspond to the input question 310 and the selected property, as opposed to any property for which a response corresponds to the input question 310). In some implementations, the selected property information 312 may include a property name and address, or other information, such as a phone number, an e-mail address, a website, a social media link, an image or graphic, a combination thereof, or the like. In some implementations, the selected property information 312 may also include, or may be replaced with, entity information associated with an entity that manages the property. For example, if responses are stored in association with entities instead of properties (e.g., MDUs), the selected property information 312 may be replaced with an entity name, address, phone number, e-mail address, website, social media link, or the like. The selected property information 312 may be configurable by a user, such as via a text input, a dropdown menu, a file selection icon, or the like.

When the input question 310 is entered, the UI 300 displays responses that are associated with the input question 310 and the selected property indicated by the selected property information 312. For example, the database may store one or more responses that correspond to a particular question to be answered by the virtual assistant, and each of the one or more responses may correspond to one or more properties for which the respective response is to be used as an answer. To illustrate, in the example shown in FIG. 3, the input question 310 and the selected property correspond to four responses, which are displayed as “Related Responses.” Each of the related responses include a selectable indicator and response text, such as an illustrative selectable indicator 320 and an illustrative response text 322. In some implementations, the related responses may be displayed in a particular order, such as a prioritized order based on priorities stored in the respective entries in the database. For example, an entry that stores the response text 322 (“Breaking a lease will result in acceleration of rent for all unpaid months in the term of the lease.”) may have a higher priority than the other responses in the example of FIG. 3. A user may select which response should have the highest priority, should be modified, or both, by selection of the respective selectable indicator. For example, the user may select the selectable indicator 320 to decrease the priority associated with the response text 322 or to enable modification or deletion of the response text 322, as non-limiting examples. Selection of a particular response may also cause display and optionally user modification of other information related to the particular response, such as training phrases, summaries, properties to link to the response, an option to approve use of the response with other entities, or the like. Additionally or alternatively, the related responses may include a selectable indicator 324 associated with an input field 326. Upon selection of the selectable indicator 324, the user may enter a user-created response via the input field 326. Additional information may also be displayed for user creation, such as a priority, training phrases, properties to associate with the user-created response, an option to approve use of the response with other entities, or the like. Once a response is selected and optionally modified, or a new response is created, the updates are provided to the database for updating an existing entry or storage of a new entry. Thus, the UI 300 enables an entity (e.g., a manager of one or more MDUs) to dynamically manage responses of a virtual assistant from a user-friendly UI, instead of reprogramming code of the virtual assistant or using a database application to modify entries in a database.

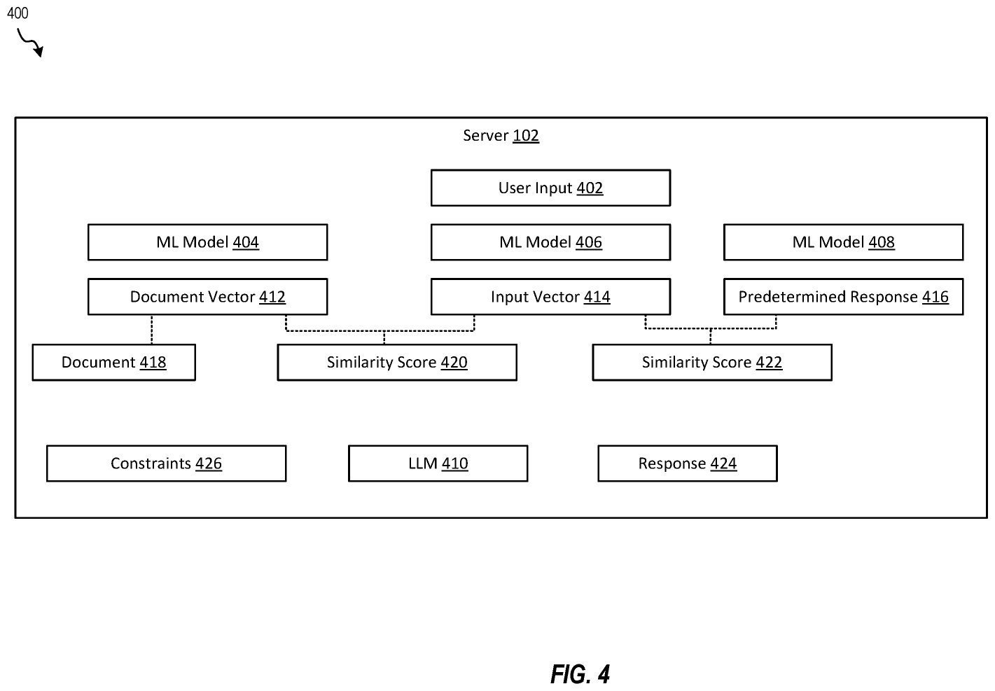

Referring to FIG. 4, a block diagram of an example of a system that supports providing responses to user inputs regarding multi-unit properties according to one or more aspects is shown and designated 400. The system 400 may include or correspond to the system 100 of FIG. 1. For example, the system 400 includes the server 102. As another example, all or part of the system 400 may be implemented within the response manager 122. As further described below, the server 102 may include one or more additional components to enable performance of the operations described below. It is to be noted, however, that a system may include any or all of the components of the system 100 and the system 400, and accordingly a single system may perform some or all of the operations described herein with reference to FIG. 1 and FIG. 4. As shown in FIG. 4, in addition to the components shown in FIG. 1, which are not reproduced in FIG. 4 for clarity, the server 102 includes a user input 402, machine learning models 404, 406, 408, an input vector 414, a document vector 412, a document 418 corresponding to the document vector 412, a predetermined response 416, similarity scores 420, 422, a large language model (LLM) 410, a response 424, and predefined constraints 426.

The system 400 may be configured to determine and present responses to questions received from users, such as questions received as user input 402 from one or more users. To do so, the server 102 may be configured to generate an input vector 414 based on user input 402 that indicates a question regarding a first property (such as an MDU). In particular, the question may correspond to one or more property characteristics of the first property. Property characteristics may include physical characteristics regarding a property (such as the size of the property, size of particular units, common spaces, and the like), amenities available at the property (such as whether the property has a pool, a cafe, a meeting room, and the like), staff availability at the property (such as whether the property has a receptionist, a manager, hours during which the property is staffed, and the like), or any other characteristic, attributes, or aspects of a property. In different instances, user input 402 may be received from one of a plurality of types of users. For example, the one or more users may include a current resident/tenant, a prospective resident/tenant, a property manager, an investor, a seller, a buyer, a prospective buyer, and the like. The user input 402 may be received from the user via a digital assistant or chat interface. For example, the user input 402 may be received via a chat interface implemented on a user device 134, an entity device 130, or a combination thereof. The user input 402 may be received as text data, such as text data entered by a user by the interface. In additional or alternative implementations, the user input 402 may be received as non-text data. For example, the user may verbally ask a question to the digital assistant, and the user input 402 may be received as audio data containing the contents of the user's spoken question. In such implementations, the server 102 may be configured to convert the user input 402 into text data and the input vector 414 may be determined based on the text data.

In certain implementations, generating the input vector 414 may include extracting contextual details from the user input 402. In such instances, the input vector 414 may be generated based on the contextual details. Contextual details may include one or more semantic features extracted from the user input 402 (such as from the contents of the question indicated by the user input 402). In certain implementations, contextual details may include details from other sources (such as previous communications with the user, a profile associated with the user, selected options for the current conversation, and the like).

In particular, the input vector may represent a machine-interpretable representation of the user's query, formatted to enable compatibility with subsequent machine learning operations within the response determination system. For example, the generated input vector may encapsulate the user's question in a structured format suitable for comparison with a database of pre-existing vectors (e.g., document vectors). The input vector 414 may be determined using natural language processing techniques to extract the semantic and contextual content from the user input 402. For example, the input vector 414 may be determined using one or more of the techniques described above for determining document vectors based on received documents (e.g., by applying such techniques to the contents of the user input 402). In certain implementations, the input vector 414 may be determined by a machine learning model 406. In such instances, generating the input factor 414 may include providing the user input 402 to the machine learning model 406 and receiving the input vector 414 from the machine learning model 406. In such instances, the machine learning model 406 may be trained to extract contextual details from user input 402 and to determine input vectors based on the contextual details.

The server 102 may be configured to provide the input vector 414 to a machine learning model 404 to identify a document vector 412 based on the input vector 414. In particular, the machine learning model 404 may be configured to identify one or more document vectors 412 associated with one or more documents 418 that are relevant to the question indicated within the user input 402. To do so, the first machine learning model 404 may be configured to query a document vector database (such as one of the databases 132) to identify the document vector 412 that may be most similar to the input vector 414. As explained further below, the document vector database may be formed by receiving and determining corresponding document vectors for a plurality of documents that describe aspects or characteristics of one or more properties. In particular, the document vector 412 may correspond to a summary of a document 418 in a knowledge database containing summaries of a plurality of documents associated with a plurality of properties, and the plurality of properties may include the first property.

In certain implementations, the machine learning model 404 may be configured to identify a single corresponding document vector 412 for the input vector 414. For example, the machine learning model 404 may identify the document vector 412 within the knowledge database that has the highest similarity score with the input vector 414. In additional or alternative implementations, the machine learning model 404 may identify more than one corresponding document vector 412 for the input vector 414. For example, the machine learning model 404 may return document vectors 412 that satisfy a predetermined threshold (such as a maximum number of document vectors 412 that satisfy the threshold, all of the document vectors 412 that satisfy the threshold).

In certain implementations, the user may be associated with an access level. In particular, different types of users may be associated with different access levels, which are enabled to access different amounts of information regarding properties. For example, an entity user (such as a property manager) may have a higher access level (and may be able to access more data and/or documents regarding a property) than a resident of the property. As another example, a resident of the property may have a higher access level than a prospective tenant for the property. As a particular example, an entity user may be able to access information regarding maintenance timelines and maintenance status for a unit, but a resident of the unit may not be able to access this information. However, an entity user and a resident may both be able to access rent payment information concerning the unit. The server 102 may enforce access levels by limiting the documents 418 for which document vectors 412 are identified by the machine learning model 404. In certain implementations, if the document vector 412 corresponds to a document 418 that is outside of the user's access level, the server 102 may request that the machine learning model 404 identify a different document vector. In additional or alternative implementations, the machine learning model 404 may be configured to receive, from the server 102, an indication of an access level for the user, and may only identify document vectors 412 for which the user has access (such as by limiting a subset of the knowledge database considered by the machine learning model 404 when identifying the document vector 412).

The server 102 may be configured to determine responses 424 to the user input 402 based on the document vector 412 or based on one or more predetermined responses 416, which may be manually entered by users (such as property managers). To do so, the server 102 may be configured to identify a predetermined response 416 from the plurality of predetermined responses. In certain implementations, the predetermined response 416 may be identified as the predetermined response from the plurality of predetermined responses that is most similar to the input vector 414.

In certain implementations, the predetermined response 416 may be determined by a machine learning model 408. The machine learning model 408 may be configured to identify predetermined responses from the plurality of predetermined responses based on training phrases associated with the predetermined responses (e.g., based on similarity scores between the training phrases and the input vector 414, the user input 402, or combinations thereof). In additional or alternative implementations, the machine learning model 408 may be configured to identify predetermined responses based on vector representations of the predetermined responses 416. For example, vector representations may be determined and included for responses stored within the response database in the databases 132. In such instances, the predetermined response 416 may be selected based on similarity scores between vectors associated with the predetermined responses and the input vector 414. The machine learning model 408 may identify the predetermined response 416 that has the highest similarity score with the input vector 414. In additional or alternative implementations, the machine learning model 404 may identify more than one predetermined response 416 for the input vector 414. For example, the machine learning model 408 may return predetermined responses that satisfy a predetermined threshold (such as a maximum number of predetermined responses that satisfy the threshold, all of the predetermined responses that satisfy the threshold).

To select between determining the response 424 based on the document vector 412 in the predetermined response 416, the server 102 may compute similarity scores 420, 422 corresponding to the document vector 412 and the predetermined response 416. In particular, the server 102 may determine a first similarity score 420 based on the document vector 412 in the input vector 414 and may determine a second similarity score 422 based on the predetermined response 416 and the input vector 414. The similarity scores 420, 422 may be computed by a machine learning model, such as a vector similarity scoring model, that is trained to quantitatively assess the correspondence between vectors. The similarity scores 420, 422 may be numerical representations (e.g., normalized representations) that indicate the extent of semantic and contextual agreement between the input vector and each comparand—either the document vector or the predetermined response. The server 102 may determine the similarity scores based on characteristics such as the vectors' orientation and proximity within a feature space, effectively quantifying the relevance of information from the document vector and the applicability of the predefined response to the user's input question. For example, the vectors 412, 414 and the predetermined response 416 (such as a vector associated with the predetermined response) may be stored using similar vectors (e.g., vectors with the same or similar features). In such instances, the scores 420, 422 may be computed by comparing values for corresponding features.

The server 102 may then be configured to compare the first similarity score 420 to the second similarity score 422. The server 102 may be configured to provide, based on the comparison of the first similarity score 420 and the second similarity score 422, the input vector 414 and one of the document vector 412 and the predetermined response 416 to a large language model (LLM) 410 to generate a response 424. In particular, if the server 102 determines that the first similarity score 420 is less than or equal to the second similarity score 422, the server 102 may be configured to determine the response 424 based on the predetermined response 416. To do so, the server 102 may provide the input vector 414 and the predetermined response 416 to the LLM 410. If the server 102 instead determines that the first similarity score 420 is greater than the second similarity score 422, the server 102 may be configured to determine the response 424 based on the document vector 412. To do so, the server 102 may provide the document vector 412 and the input vector 414 to the LLM 410. In certain implementations, the server 102 may provide portions of both the document vector 412 and the predetermined response 416 to the LLM 410. For example, a predetermined response 416 may reference (e.g., link to) a lease for a property. In such instances, relevant portions of the lease may be provided to the LLM (e.g., as a document vector).

In certain implementations, information provided to the LLM 410 (such as the input vector 414 and one of the document vector 414 and the predetermined response 416) may be provided as a prompt to the LLM 410. In certain implementations, prompts provided to the LLM 410 may exclude previous inputs received from a user (such as earlier portions of a conversation in which the user input 402 is received). By omitting extraneous information, such implementations may reduce or otherwise alleviate hallucinations in the response 424 determined by the LLM 410.

In certain implementations, the server 102 may be configured to output the response 424 as an answer to the question. In certain implementations, the response 424 may be output to a computing device from which the user input 402 was received. For example, the response 424 may be output to a user device 134, an entity device 130, or a combination thereof. In certain implementations, outputting the response 424 may include displaying the text contents of the response on a display of the receiving device (such as within a chat interface). In additional or alternative implementations, outputting the response may include generating and playing audio containing a spoken version of the response 424 (such as using one or more text-to-speech models).

Generating the response 424 in this manner may help ensure that the response presented to a user reflects the context and content appropriate to the received query. Using an LLM may help ensure that the response 424 is phrased in a manner that is readily comprehensible to the user and able to incorporate dynamic information sources (e.g., the predetermined responses, new or updated documents within a knowledge database). Notably, using an LLM may help ensure that the final output reflects a natural conversational tone, encompassing both the factual content from the knowledge repository and the nuance inferred from the input vector.

The server 102 may be configured to enforce one or more preconfigured constraints 426 on generated responses 424. For example, the constraints 426 may define stylistic requirements for answers presented to users (such as a maximum length of responses, a minimum length of responses, a maximum number of languages for responses, acceptable languages for responses, preferred stylistic tone (e.g., conversational, formal, friendly), formatting of responses, and the like). As another example, the constraints 426 may be configured to enforce access level restrictions, as discussed above. For example, different types of users may have different associated constraints 426 that are applied to responses 424 before being output to the user. The server 102 may be configured to enforce the constraints 426 using various strategies. For example, the server 102 may be configured to compare information associated with the document vector 412 against one or more constraints 426. The information may include contents of the document vector 412, contents of associated documents 418, contents of a summary of the associated document 418, or a combination thereof. If the server 102 determines that the information associated with the document vector 412 violates at least one of the plurality of pre-configured constraints (e.g., the response is longer than a maximum response length, the response includes information that the user is not permitted to access), the server 102 may be configured to select a different document vector 412. For example, the server 102 may transmit to provide a request to the machine learning model 404 to identify a different document vector 412. As another example, the server 102 may be configured to select a next-best matching document vector 412 (such as indicated by one or more associated similarity scores) that does not violate the constraint for 26 to serve as the document vector 412.

In other plantations, the constraints 426 may be additionally or alternatively enforced directly on the responses 424 generated by the LLM 410. For example, the server 102 may be configured to compare the response 424 from the LLM 410 against one or more applicable constraints 426. If the server 102 determines that the response 424 violates one or more of the constraints 426 (e.g., the response contains information that was not present within the provided document vector, the response is too informal in tone), the server 102 may request an updated response 424 from the LLM 410. For example, the server 102 may provide an indication to the LLM 410 of the violated constraints and may request the LLM to generate an updated response 424 that complies with the violated constraint.

The examples discussed herein include one or more thresholds for making one or more determinations. In these examples, it should be understood that the provided conditions (e.g., greater than, less than, equal to, greater than or equal to, less than or equal to) are merely exemplary. Unless otherwise specified, alternative implementations of the described techniques may use different conditions. For example, a comparison that is described as “greater than” may be implemented with a “less than or equal to” condition. All such implementations are considered within the scope of the present disclosure.

In certain implementations one or more of the machine learning models 404, 406, 408 and the LLM 410 may be implemented by the server 102, by another computing device, or a combination thereof. For example, the machine learning models 404, 406, 408 may be implemented by the server 102 and the LLM 410 may be implemented by another computing device (and may be accessed by a one or more API requests). In still further implementations, the server 102 may include additional or fewer machine learning models and those depicted in the system 400. For example, in certain implementations, the machine learning models 404, 408 may be implemented as a single machine learning model. As another example, the machine learning model 404 may be implemented as multiple machine learning models (such as for different types of properties, different types of property documentation, or a combination thereof. All such implementations are considered within the scope of the present disclosure.

As discussed above, the server 102 or another computing device may be configured to create and/or update a knowledge database containing the documents 418 from which the document vector 412 is identified. To do so, the server 102 may be configured to receive one or more documents that contain information associated with one or more properties (such as one or more MDUs). The server 102 may determine, for each respective document 418 of the plurality of documents, a corresponding document vector 412 based on the contents of text data within the respective document 418, such as using one or more techniques discussed herein. In certain implementations, the server 102 may be configured to identify sections of an uploaded document that are not relevant (e.g., contain information regarding a different property), sections that are duplicates of other documents, and overall weaknesses of knowledge database (e.g., aspects of a property, such as amenities, for which information has not been received). In such instances, a prompt may be provided to the user to remove irrelevant or duplicative sections and/or to upload additional documents providing information for weak areas of the knowledge database. For example, an uploaded document for a property may include a lease for the property that mentions a pool. However, previous responses received or configured for the property may indicate that the property does not have a pool. Upon receiving the document, a “pool” flag may be set based on the document, and may be compared to the responses, which may include a “no pool” flag. After identifying this conflict, a prompt may be presented to the user to reconcile the conflict (such as to select whether the property does or does not have a pool). In additional or alternative implementations, the system may automatically reconcile the conflict (such as based on a rule indicating that configured responses overrule other documents.

Referring to FIG. 5, a UI that supports document upload and processing to create a knowledge database according to one or more aspects is shown as a UI 500. The UI 500 (e.g., a GUI) may be displayed via a server (e.g., a display device coupled to the server) that executes a response generator, an administrator device (e.g., associated with a network administrator or a property manager), a user device (e.g., associated with a customer or client), or a combination thereof. In some implementations, the UI 500 may be displayed by the entity device 130 of FIG. 1. As shown in FIG. 5, the UI 500 includes the response control button 302, the import document button 304, the settings button 306, domain information 502, document information 504, one or more domain-specific questions 506, one or more extracted responses 508, and a document view 510. In other implementations, one or more of the illustrated features of the UI 500 may be optional, the UI 500 may include additional features, or both.

Upon selection of the import document button 304, the UI 500 may display the information shown in FIG. 5. The domain information 502 may include information associated with a domain of an input document. As used herein, a domain may include or correspond to a category type of the input document. The domain may be selectable by a user of the UI 500 or may be automatically determined based on analysis of the input document. The document information 504 includes information associated with the input document. For example, the document information 504 may include a title of the input document, a location (e.g., a file path) of the input document, or the like. The input document may be selectable via the UI 500 or may be specified via other controls (e.g., for batch processing). After uploading the document via the UI 500, the server 102 may be configured to determine a document vector for the document and to store the document, the document vector, or a combination thereof within the database 132 (e.g., within a knowledge database).

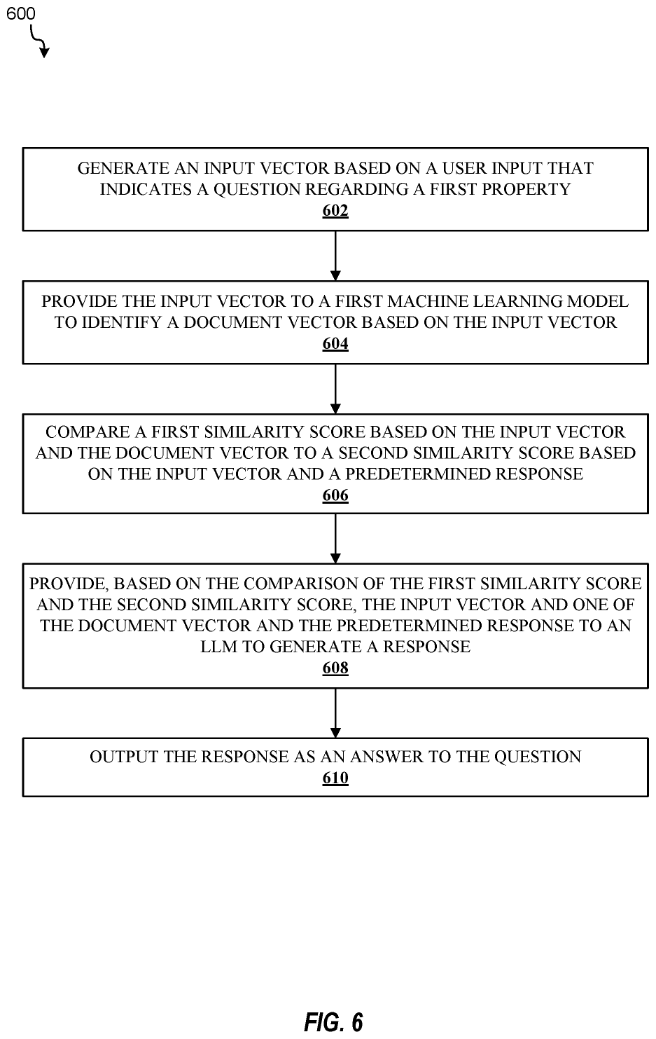

Referring to FIG. 6, a flow diagram of a method for dynamically generating responses to questions regarding properties according to one or more aspects is shown as a method 600. In some implementations, method 600 may be performed by the server 102 of FIGS. 1 and 3. In some implementations, the method 600 may be stored in a computer-readable storage medium as instructions that, when executed by one or more processors, cause the one or more processors to perform the operations of the method 600.

The method 600 includes generating an input vector based on a user input that indicates a question regarding a first property (block 602). For example, the server 102 may generate an input vector 414 based on a user input 402 that indicates a question regarding a first property. In certain implementations, generating the input vector 414 may include converting the user input 402 into text data, and the input vector 414 may be determined based on the text data. For example, if the user input 402 includes audio data containing a user's spoken question, the audio data may be converted into text data, and the text data may be used to generate the input vector 414. In certain implementations, generating the input vector 414 includes extracting contextual details from the user input 402, and the input vector 414 may be generated based on the contextual details. In certain implementations, generating the input vector 414 includes providing the user input 402 to a second machine learning model 406. The second machine learning model 406 may be trained to extract contextual details from user input 402 and to determine input vectors based on the contextual details.

The method 600 includes providing the input vector to a first machine learning model to identify a document vector based on the input vector (block 604). For example, the server 102 may provide the input vector 414 to a first machine learning model 404 to identify a document vector 412 based on the input vector 414. In certain implementations, the first machine learning model 404 may be configured to query a document database (e.g., a database containing document vectors) to identify the document vector 412 that is most similar to the input vector 414. In certain implementations, the document vector 412 corresponds to a summary of a document 418 in a knowledge database containing summaries of a plurality of documents associated with a plurality of properties, such as the database 132. The plurality of properties may include the first property for which the user input was received. In certain implementations, the user may be associated with an access level. In such instances, the document vector 412 may be selected to comply with the access level.

The method 600 includes comparing a first similarity score based on the input vector and the document vector to a second similarity score based on the input vector and a predetermined response (block 606). For example, the server 102 may compare a first similarity score 420 based on the input vector 414 and the document vector 412 to a second similarity score 422 based on the input vector 414 and a predetermined response 416. In certain implementations, the predetermined response 416 may be selected as having the highest similarity measure to the input vector 414 from among a plurality of predetermined responses.

The method 600 includes providing, based on the comparison of the first similarity score and the second similarity score, the input vector and one of the document vector and the predetermined response to an LLM to generate a response (block 608). For example, the server 102 may provide, based on the comparison of the first similarity score 420 and the second similarity score 422, the input vector 414 and one of the document vector 412 and the predetermined response 416 to an LLM 410 to generate a response 424. In certain implementations, the server 102 may determine that the first similarity score 420 is less than or equal to the second similarity score 422 and, in response, may provide the input vector 414 and the predetermined response 416 to the LLM 410 to generate the response 424. In certain implementations, the server 102 may determine that the first similarity score 420 is greater than the second similarity score 422 and, in response, may provide the input vector 414 and the document vector 412 to the LLM 410 to generate the response 424.

The method 600 includes outputting the response as an answer to the question (block 410). For example, the server 102 may output the response 424 as an answer to the question. In particular, the response 424 may be output via a device from which the user input 402 was received (such as the user device 134, the entity device 130, or combinations thereof). In certain implementations, outputting the response 424 may include displaying, via a GUI on the device, contents of the response 424 (such as within a digital assistant chat interface).

In certain implementations, the method 600 may include enforcing one or more preconfigured constraints 426. For example, the method 600 may include comparing information associated with the document vector 412 to a plurality of preconfigured constraints, determining that the information associated with the document vector 412 violates at least one of the plurality of preconfigured constraints, and selecting a different document vector 412. As another example, the method 600 may include comparing the response 424 from the LLM 410 to a plurality of preconfigured constraints 426, determining that the response 424 violates at least one of the plurality of preconfigured constraints, and providing an indication of the violated constraint to the LLM to generate an updated response 424.

The method 600 may further include receiving the plurality of documents that contain information associated with a plurality of multi-unit properties (e.g., MDUs) and determining, for each respective document 418 of the plurality of documents, a corresponding document vector 412 based on the contents of text data within the respective document 418.

In some implementations, methods can be combined with other operations described herein. For example, one or more operations of the method 600 of FIG. 6 may be combined with one or more operations described with reference to FIGS. 1-5.

Although one or more of the disclosed figures may illustrate systems, apparatuses, methods, or a combination thereof, according to the teachings of the disclosure, the disclosure is not limited to these illustrated systems, apparatuses, methods, or a combination thereof. One or more functions or components of any of the disclosed figures as illustrated or described herein may be combined with one or more other portions of another function or component of the disclosed figures. Accordingly, no single implementation described herein should be construed as limiting and implementations of the disclosure may be suitably combined without departing from the teachings of the disclosure.

The steps of a method or algorithm described in connection with the implementations disclosed herein may be included directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

Although the present disclosure and its advantages have been described in detail, it should be understood that various changes, substitutions and alterations can be made herein without departing from the scope of the present disclosure as defined by the appended claims. Moreover, the scope of the present application is not intended to be limited to the particular aspects of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or steps.

1. A method comprising:
generating an input vector based on a user input that indicates a question regarding a first property characteristic of a plurality of property characteristics associated with a knowledge database;
providing the input vector to a first machine learning model to identify a document vector within the knowledge database and associated with the first property characteristic based on the input vector;
comparing a first similarity score based on the input vector and the document vector to a second similarity score based on the input vector and a response of a plurality of responses of a response database, the response associated with the first property characteristic;
providing, based on the comparison of the first similarity score and the second similarity score, the input vector and at least one of (i) the document vector, (ii) the response, or (iii) a combination thereof to a large language model (LLM) to generate response content; and
outputting the response content as an answer to the question.

2. The method of claim 1, wherein comparing the first similarity score to the second similarity score comprises determining that the first similarity score is less than or equal to the second similarity score, and
wherein providing, based on the comparison of the first similarity score and the second similarity score, the input vector and one of (i) the document vector, (ii) the response, or (iii) a combination thereof to the LLM comprises providing the input vector and the predetermined response to the LLM to generate the response content.

3. The method of claim 1, wherein comparing the first similarity score to the second similarity score comprises determining that the first similarity score is greater than the second similarity score, and
wherein providing, based on the comparison of the first similarity score and the second similarity score, the input vector and one of (i) the document vector, (ii) the response, or (iii) a combination thereof to the LLM comprises providing the input vector and the document vector to the LLM to generate the response content.

4. The method of claim 1, wherein the response is selected as having the highest similarity measure to the input vector from among a plurality of predetermined responses.

5. The method of claim 1, wherein the first machine learning model is configured to query a document vector database to identify the document vector that is most similar to the input vector.

6. The method of claim 5, wherein the knowledge database contains summaries of a plurality of documents associated with the plurality of properties.

7. The method of claim 6, further comprising, prior to generating the input vector:
receiving the plurality of documents that contain information associated with a plurality of multi-unit properties; and
determining, for each respective document of the plurality of documents, a corresponding document vector based on text data within the respective document.

8. The method of claim 1, further comprising:
comparing information associated with the document vector to a plurality of constraints, wherein the constraints are defined based on user input;
determining that the information associated with the document vector violates at least one of the plurality of constraints; and
selecting a different document vector.

9. The method of claim 8, wherein the constraints comprise access level permissions for the knowledge database associated with the user.

10. The method of claim 1, further comprising:
comparing the response from the LLM to a plurality of constraints, wherein the constraints are defined based on user input;
determining that the response violates at least one of the plurality of constraints; and
providing an indication of the at least one of the plurality of constraints to the LLM to generate updated response content.

11. The method of claim 10, wherein the constraints comprise stylistic requirements for answers presented to users.

12. The method of claim 1, further comprising converting the user input into text data, wherein the input vector is determined based on the text data.

13. The method of claim 1, wherein generating the input vector comprises extracting contextual details from the user input, wherein the input vector is generated based on the contextual details.

14. The method of claim 11, wherein generating the input vector further comprises providing the user input to a second machine learning model, wherein the second machine learning model is trained to extract contextual details from user input and to determine input vectors based on the contextual details.

15. A system comprising:
a processor; and
a memory storing instructions which, when executed by the processor, cause the processor to perform operations including:
generating an input vector based on a user input that indicates a question regarding a first property characteristic of a plurality of property characteristics associated with a knowledge database;
providing the input vector to a first machine learning model to identify a document vector within the knowledge database and associated with the first property characteristic based on the input vector;
comparing a first similarity score based on the input vector and the document vector to a second similarity score based on the input vector and a response of a plurality of responses of a response database, the response associated with the first property characteristic;
providing, based on the comparison of the first similarity score and the second similarity score, the input vector and at least one of (i) the document vector, (ii) the response, or (iii) a combination thereof to a large language model (LLM) to generate response content; and
outputting the response content as an answer to the question.

16. The system of claim 15, wherein comparing the first similarity score to the second similarity score comprises determining that the first similarity score is less than or equal to the second similarity score, and
wherein providing, based on the comparison of the first similarity score and the second similarity score, the input vector and one of (i) the document vector, (ii) the response, or (iii) a combination thereof to the LLM comprises providing the input vector and the predetermined response to the LLM to generate the response content.

17. The system of claim 15, wherein comparing the first similarity score to the second similarity score comprises determining that the first similarity score is greater than the second similarity score, and
wherein providing, based on the comparison of the first similarity score and the second similarity score, the input vector and one of (i) the document vector, (ii) the response, or (iii) a combination thereof to the LLM comprises providing the input vector and the document vector to the LLM to generate the response content.

18. The system of claim 15, wherein the first machine learning model is configured to query a document vector database to identify the document vector that is most similar to the input vector.

19. The system of claim 15, wherein the operations further comprise:
comparing information associated with the document vector to a plurality of constraints, wherein the constraints are defined based on user input;
determining that the information associated with the document vector violates at least one of the plurality of constraints; and
selecting a different document vector.

20. The system of claim 15, wherein the operations further comprise:
comparing the response from the LLM to a plurality of constraints, wherein the constraints are defined based on user input;
determining that the response violates at least one of the plurality of constraints; and
providing an indication of the at least one of the plurality of constraints to the LLM to generate updated response content.
